(19) United States
(12) Patent Application Publication
(10) Pub. No.: US 2019/0291086 A1
(43) Pub. Date: Sep. 26, 2019

(54) CATALYST FOR HYDRODESULFURIZATION OF COKE OVEN GAS AND METHOD OF PREPARING THE CATALYST

(71) Applicant: Xi'an Sunward Aerospace Material Co., Ltd., Xi'an (CN)

(72) Inventors: Longlong XU, Xi'an (CN); Dong PENG, Xi'an (CN); Yanan HOU, Xi'an (CN); Rong LI, Xi'an (CN); Yang YU, Xi'an (CN); Yimin FENG, Xi'an (CN)

(21) Appl. No.: 16/361,182

(22) Filed: Mar. 21, 2019

(30) Foreign Application Priority Data
Mar. 22, 2018 (CN) 201810239284.8

(51) Int. Cl. B01J 27/19; B01J 21/12; B01J 21/02; C10G 45/04

(52) U.S. Cl. CPC B01J 27/19; C10G 45/04; B01J 21/02; B01J 21/12

(57) ABSTRACT

A catalyst, including: 0.1-6.0 wt. % of SiO₂; 8.0-20.0 wt. % of MoO₃; 74.8-91.89 wt. % of Al₂O₃; and the balance is P₂O₅ and/or B₂O₃. A method of preparing the catalyst includes: dissolving ammonium molybdate in water or ammonia water, followed by addition of a silicon precursor, to yield a first mixed solution; stirring and adding an acid to the first mixed solution to yield a second mixed solution; and adding Al₂O₃ to the second mixed solution, and drying and calcining the resulting product.

### CROSS-REFERENCE TO RELATED APPLICATIONS

Pursuant to 35 U.S.C. § 119 and the Paris Convention Treaty, this application claims foreign priority to Chinese Patent Application No. 201810239284.8 filed Mar. 22, 2018, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

This disclosure relates to a catalyst for hydrodesulfurization of coke oven gas and a method of preparing the catalyst.

Conventional catalysts for hydrogenation of coke oven gas include metal oxides of molybdenum (Mo), iron (Fe), or nickel (Ni). Treatment with activating agents, such as carbon disulfide or dimethyl disulfide, is required prior to use of the catalysts. The treatment produces gaseous sulfur dioxide, leading to environmental pollution. In addition, conventional hydrogenation catalysts exhibit poor heat resistance.

### SUMMARY

Disclosed is a catalyst for hydrodesulfurization of coke oven gas. The catalyst comprises a first accelerator: silicon (Si), and a second accelerator: boron (B) and/or phosphorus (P). These need not be activated.

Disclosed is a catalyst for hydrodesulfurization of coke oven gas, the catalyst comprising: 0.1-6.0 wt. % of SiO₂; 8.0-20.0 wt. % of MoO₃; 74.8-91.89 wt. % of Al₂O₃; and the balance is: P₂O₅ and/or B₂O₃.

Mo functions as an active component. Si functions as a first accelerator. B and/or P function as a second accelerator. Al₂O₃ functions as a carrier.

The catalyst can comprise 0.3-3.0 wt. % of SiO₂; 8.0-12.0 wt. % of MoO₃; 84.8-91.69 wt. % of Al₂O₃; and the balance is: P₂O₅ and/or B₂O₃. The catalyst can comprise 0.3 wt. % of SiO₂; 9.0 wt. % of MoO₃; 90.6 wt. % of Al₂O₃; and the balance is: P₂O₅ and/or B₂O₃.

Also provided is a method of preparing the catalyst, the method comprising:
1) dissolving ammonium molybdate in water or ammonia water, followed by addition of a silicon precursor, to yield a first mixed solution;
2) stirring and adding an acid to the first mixed solution, to yield a second mixed solution; and
3) adding Al₂O₃ to the second mixed solution and drying and calcining the resulting product.

The silicon precursor can be tetramethoxysilane, trimethoxysilane, tetraethoxysilane, or a mixture thereof.

The acid can be sulfuric acid, nitric acid, phosphoric acid, hydrochloric acid, oxalic acid, citric acid, boric acid, or a mixture thereof; and the addition amount of the acid can be 1-3 times based on weight of the silicon precursor.

In 3), the drying temperature can be 120° C., and the drying time can be 12 hours. In 3), the calcining temperature can be 300-550° C., and the calcining time can be 1-10 hours.

Advantages of the catalyst as described in the disclosure are summarized as follows.

1. The catalyst exhibits an improved catalytic activity and sintering resistance.

2. The catalyst has a relatively low sulfur tolerance and exhibits a relatively high catalytic performance under a low concentration of hydrogen sulfide.

3. The accelerator silicon need not be activated, which keeps the production cost of the catalyst low.

4. The preparation method of the catalyst is efficient, environmentally friendly, and cost-effective.

### DETAILED DESCRIPTION

To further illustrate, embodiments detailing a catalyst for hydrodesulfurization of coke oven gas are described below. It should be noted that the following embodiments are intended to describe and not to limit the disclosure.

### Example 1

A hydrodesulfurization catalyst comprises 0.1 wt. % of SiO₂, 0.1 wt. % of B₂O₃, 8.0 wt. % of MoO₃, and 91.8 wt. % of Al₂O₃. The catalyst is prepared as follows. 18.9 g of ammonium dimolybdate was dissolved in 110 g of water, followed by addition of 0.5 g of tetramethoxysilane. The resulting mixture was stirred, and then 0.30 g of sulfuric acid, 0.04 g of boric acid, and 184 g of Al₂O₃ were added. The resulting product was dried at 120° C. for 12 hours, and then calcined at 500° C. for 2 hours.

### Example 2

A hydrodesulfurization catalyst comprises 0.1 wt. % of SiO₂, 0.1 wt. % of P₂O₅, 8.0 wt. % of MoO₃, and 91.8 wt. % of Al₂O₃. The catalyst is prepared as follows. 18.9 g of ammonium dimolybdate was dissolved in 110 g of water, followed by addition of 0.25 g of tetramethoxysilane and 0.2 g of trimethoxysilane. The resulting mixture was stirred, and then 0.30 g of sulfuric acid, 0.03 g of phosphoric acid, and 184 g of Al₂O₃ were added. The resulting product was dried at 120° C. for 12 hours, and then calcined at 500° C. for 2 hours.

### Example 3

A hydrodesulfurization catalyst comprises 1.0 wt. % of SiO₂, 0.2 wt. % of B₂O₃, 9.0 wt. % of MoO₃, and 89.8 wt. % of Al₂O₃. The catalyst is prepared as follows. 19.6 g of ammonium tetramolybdate was dissolved in 90 g of water, and ammonia water was added to the resulting solution to adjust the pH value thereof to 9. Thereafter, 6.9 g of tetraethoxysilane was added. The resulting mixture was stirred, and then 8.0 g of nitric acid, 0.7 g of boric acid, and 180 g of Al₂O₃ were added. The resulting product was dried at 120° C. for 12 hours, and then calcined at 300° C. for 10 hours.

### Example 4

A hydrodesulfurization catalyst comprises 1.0 wt. % of SiO₂, 0.2 wt. % of P₂O₅, 12.0 wt. % of MoO₃, and 86.8 wt. % of Al₂O₃. The catalyst is prepared as follows. 29.4 g of ammonium heptamolybdate was dissolved in 100 g of water, followed by addition of 4.1 g of trimethoxysilane. The resulting mixture was stirred, and then 9.0 g of hydrochloric acid, 0.6 g of phosphoric acid, and 174 g of Al₂O₃ were added. The resulting product was dried at 120° C. for 12 hours, and then calcined at 450° C. for 2 hours.

### Example 5

A hydrodesulfurization catalyst comprises 6.0 wt. % of SiO₂, 1.0 wt. % of B₂O₃, 1.0 wt. % of P₂O₅, 15.0 wt. % of MoO₃, and 77 wt. % of Al₂O₃. The catalyst is prepared as follows. 35.4 g of ammonium dimolybdate was dissolved in 90 g of water, followed by addition of 10.16 g of tetramethoxysilane, 8.15 g of trimethoxysilane, and 13.9 g of tetraethoxysilane. The resulting mixture was stirred, and then 20 g of nitric acid, 3.2 g of phosphoric acid, 3.6 g of boric acid, and 154 g of Al₂O₃ were added. The resulting product was dried at 120° C. for 12 hours, and then calcined at 550° C. for 1 hour.

### Example 6

A hydrodesulfurization catalyst comprises 5.0 wt. % of SiO₂, 0.2 wt. % of B₂O₃, 20.0 wt. % of MoO₃, and 74.8 wt. % of Al₂O₃. The catalyst is prepared as follows. 40.0 g of ammonium dimolybdate was dissolved in 90 g of water, followed by addition of 25.4 g of tetramethoxysilane. The resulting mixture was stirred, and then 20 g of citric acid, 0.7 g boric acid, and 150 g of Al₂O₃ were added. The resulting product was dried at 120° C. for 12 hours, and then calcined at 450° C. for 2 hours.

### Example 7

A hydrodesulfurization catalyst comprises 0.3 wt. % of SiO₂, 0.2 wt. % of P₂O₅, 9.0 wt. % of MoO₃, and 90.5 wt. % of Al₂O₃. The catalyst is prepared as follows. 22.1 g of ammonium heptamolybdate was dissolved in 105 g of water, followed by addition of 1.5 g of tetramethoxysilane. The resulting mixture was stirred, and then 0.9 g of oxalic acid, 0.6 g phosphoric acid, and 181 g of Al₂O₃ were added. The resulting product was dried at 120° C. for 12 hours, and then calcined at 400° C. for 5 hours.

### Example 8

A hydrodesulfurization catalyst comprises 0.3 wt. % of SiO₂, 0.1 wt. % of B₂O₃, 9.0 wt. % of MoO₃, and 90.6 wt. % of Al₂O₃. The catalyst is prepared as follows. 22.1 g of ammonium heptamolybdate was dissolved in 105 g of water, followed by addition of 1.5 g of tetramethoxysilane. The resulting mixture was stirred, and then 0.7 g of oxalic acid, 0.4 g boric acid, and 181 g of Al₂O₃ were added. The resulting product was dried at 120° C. for 12 hours, and then calcined at 400° C. for 5 hours.

### Example 9

A hydrodesulfurization catalyst comprises 0.3 wt. % of SiO₂, 0.1 wt. % of P₂O₅, 9.0 wt. % of MoO₃, and 90.6 wt. % of Al₂O₃. The catalyst is prepared as follows. 22.1 g of ammonium heptamolybdate was dissolved in 105 g of water, followed by addition of 1.5 g of tetramethoxysilane. The resulting mixture was stirred, and then 0.6 g of oxalic acid, 0.3 g phosphoric acid, and 181 g of Al₂O₃ were added. The resulting product was dried at 120° C. for 12 hours, and then calcined at 400° C. for 5 hours.

### Example 10

A hydrodesulfurization catalyst comprises 3.0 wt. % of SiO₂, 0.2 wt. % of P₂O₅, 12.0 wt. % of MoO₃, and 84.8 wt. % of Al₂O₃. The catalyst is prepared as follows. 29.4 g of ammonium heptamolybdate was dissolved in 105 g of water, followed by addition of 15.2 g of tetramethoxysilane. The resulting mixture was stirred, and then 0.6 g of oxalic acid, 0.6 g phosphoric acid, and 181 g of Al₂O₃ were added. The resulting product was dried at 120° C. for 12 hours, and then calcined at 400° C. for 5 hours.

### Comparison Example 1

A purchased Fe—Mo catalyst comprises 2.8 wt. % of Fe₂O₃, 9.0 wt. % of MoO₃, and Al₂O₃. The catalyst is produced by Xi′an Sunward Aeromat Co., Ltd, with the type of TH-4.

### Comparison Example 2

A hydrodesulfurization catalyst comprises 0.1 wt. % of SiO₂, 8.0 wt. % of MoO₃, and 91.9 wt. % of Al₂O₃. The catalyst is prepared as follows. 18.9 g of ammonium dimolybdate was dissolved in 110 g of water, followed by addition of 0.5 g of tetramethoxysilane. The resulting mixture was stirred, and then 0.33 g of sulfuric acid, and 184 g of Al₂O₃ were added. The resulting product was dried at 120° C. for 12 hours, and then calcined at 500° C. for 2 hours.

Detection of catalyst activity: 0.5 mL of the catalyst was loaded to a 4-mm-inner-diameter quartz tube fixed bed reactor. The feed gas passed through the catalyst bed. The reaction pressure was atmospheric and the feed gas was hydrogen containing 10% (v/v) of thiophene. The flow rate of the feed gas was 1.2 L/h, and the reaction temperature was 360° C. Prior to reaction, the catalyst was activated by a mixture gas of carbon disulfide and hydrogen. The volume content of the carbon disulfide in the mixed gas was 20%. The reaction conditions were as follows: reaction temperature 360° C., space velocity of the feed gas 500 h⁻¹. The heat-resistant reaction temperature of the catalyst was 500° C., and the pressure and space velocity remained unchanged. The test results of the catalytic performance of the catalysts are shown in Table 1.

TABLE 1
Test results of the catalytic performance of catalysts

| | Conversion of thiophene (%) | |
|---|---|---|
| Catalysts | Initial activity (%) | Activity at 500° C. for 2 h (%) |
| Example 1 | 46.1 | 32.4 |
| Example 2 | 46.0 | 32.3 |
| Example 3 | 50.8 | 36.5 |
| Example 4 | 53.6 | 38.5 |
| Example 5 | 56.3 | 40.5 |
| Example 6 | 48.5 | 33.2 |
| Example 7 | 61.1 | 43.5 |
| Example 8 | 49.6 | 35.2 |
| Example 9 | 49.9 | 36.2 |
| Example 10 | 50.2 | 37.2 |
| Comparison | 47.8 | 21.5 |
| Example 1 | | |
| Comparison | 45.5 | 32.0 |
| Example 2 | | |

As shown in Table 1, the catalysts in Examples 1-9 are apparently superior to the purchased catalysts with regard to the catalytic performance. The MoO₃ content of the catalysts in Examples 3, 7, 8, 9 and Comparison examples 1 are all 9 wt. %. However, the catalysts prepared in the disclosure are superior to the catalyst in Comparison examples 1 in the heat resistance. Thus, the molybdenum-based catalysts comprising silicon can effectively solve the problem of poor tolerance of existing catalysts and have improved catalytic activities. Based on the catalyst activities of the catalysts in Comparison example 1, Example 2, and Comparison example 2, the hydrodesulfurization catalysts prepared in the disclosure are a Si—Mo catalyst, and introducing a small amount of phosphorus or/and boron can improve the catalytic performance and sintering resistance of the catalysts. The tests show that the Mo-based catalysts prepared in the disclosure have good performance, and their activity is obviously higher than that of the existing industrial Fe—Mo catalyst.

The catalysts in Example 7 and Comparison example 1 are used for desulfurization tests of coke oven gas. The components of the coke oven gas are shown in Table 2.

TABLE 2
Components of coke oven gas for desulfurization test

| CH₄ | CO₂ | CO | C₂H₄ | C₂H₆ | O₂/Ar | N₂ | H₂ | C₃H₆ | H₂S | Organic sulfur |
|---|---|---|---|---|---|---|---|---|---|---|
| mol % | mol % | mol % | mol % | mol % | mol % | mol % | mol % | mol % | mg/m³ | mg/m³ |
| 19.076 | 3.673 | 10.801 | 2.146 | 0.404 | 0.8 | 5.518 | 57.528 | 0.054 | 15 | 115 |

Desulfurization conditions: pressure, 1.6 megapascal; catalyst loading amounts, 1.0 mL; reactor: stainless steel reactor with an inner diameter of 7.5 mm; gas flow of raw coke oven: 4.0 L/h; reaction temperature is 450° C. Prior to reaction, the catalysts were activated by a mixture gas of carbon disulfide and hydrogen. The volume content of the carbon disulfide in the mixed gas was 20%. The reaction conditions were as follows: reaction temperature 360° C., space velocity of the feed gas 500 h⁻¹. Following the activation, the coke oven gas was introduced for desulfurization reaction, and the experimental results were shown in Table 3.

TABLE 3
Test results of desulfurization of coke oven gas using
catalysts in Example 7 and Comparison example 1

| | Conversion of organic sulfur (%) | |
|---|---|---|
| Catalysts | Initial activity | Activity after 500 hours' reaction |
| Example 7 | >99.9 | 97.2 |
| Comparison | >99.9 | 86.1 |
| example 1 | | |

As shown in Table 3, because the reaction temperature is relatively high, both the desulfurization catalyst prepared in Example 7 and the Fe—Mo catalyst in Comparison example 1 show high initial activity. However, after 500 hours' catalytic reaction, the catalytic activity of the catalyst in Comparison example 1 is significantly smaller than that of the catalyst in Example 7. This shows that the catalyst prepared by the disclosure exhibits better temperature resistance in the desulfurization process.

It will be obvious to those skilled in the art that changes and modifications may be made, and therefore, the aim in the appended claims is to cover all such changes and modifications.

What is claimed is:

1. A composition of matter, comprising:
0.1-6.0 wt. % of SiO₂;
8.0-20.0 wt. % of MoO₃;
74.8-91.89 wt. % of Al₂O₃; and
the balance of P₂O₅ and/or B₂O₃.

2. The composition of matter of claim 1, comprising:
0.3-3.0 wt. % of SiO₂;
8.0-12.0 wt. % of MoO₃;
84.8-91.69 wt. % of Al₂O₃; and
the balance of P₂O₅ and/or B₂O₃.

3. The composition of matter of claim 2, comprising:
0.3 wt. % of SiO₂;
9.0 wt. % of MoO₃;
90.6 wt. % of Al₂O₃; and
the balance of P₂O₅ and/or B₂O₃.

4. A method of preparing the composition of matter of claim 1, the method comprising:
1) dissolving ammonium molybdate in water or ammonia water, followed by addition of a silicon precursor, to yield a first mixed solution;
2) stirring and adding an acid to the first mixed solution, to yield a second mixed solution; and
3) adding Al₂O₃ to the second mixed solution and drying and calcining a resulting product.

5. The method of claim 4, wherein the silicon precursor is tetramethoxysilane, trimethoxysilane, tetraethoxysilane, or a mixture thereof.

6. The method of claim 4, wherein the acid is sulfuric acid, nitric acid, phosphoric acid, hydrochloric acid, oxalic acid, citric acid, boric acid, or a mixture thereof; and an addition amount of the acid is 1-3 times based on weight of the silicon precursor.

7. The method of claim 4, wherein in 3), a drying temperature is 120° C., and a drying time is 12 hours.

8. The method of claim 4, wherein in 3), a calcining temperature is 300-550° C., and a calcining time is 1-10 hours.
